(19) United States
(12) Patent Application Publication
(10) Pub. No.: US 2008/0310767 A1
(43) Pub. Date: Dec. 18, 2008

(54) Expandable Emesis Containment System and Use Thereof

(76) Inventors: Edward Joseph Engel, Des Peres, MO (US); Kelly Anne Engel, Des Peres, MO (US); Tricia Lynn Engel, Ballwin, MO (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/695,481

(22) Filed: Apr. 2, 2007

Related U.S. Application Data
(60) Provisional application No. 60/787,523, filed on Apr. 27, 2006.

(51) Int. Cl. B65D 30/02; B65D 30/10; B65D 33/16; B65F 1/06

(52) U.S. Cl. 383/33; 383/61.1; 206/554; 206/459.1; 221/45

(57) ABSTRACT

The present invention relates to an improved disposable emesis containment system comprising an expandable bag constituted of a non-porous, flexible polymeric material, such bag having a metal or plastic frame e.g., in the shape of a spring that permits expansion of the bag into a desired shape e.g. spherical, the bag having a large opening or aperture at the top upon expansion which opening is sealable by use of an associated draw- or pull-string and which expandable bag is stored in an easily opened, preferably resealable storage container in unexpanded form prior to usage. This system provides an improved means of storing and disposal of emesis and other noxious biological materials.

### RELATED APPLICATIONS

This application claims priority to and incorporates by reference in its entirety U.S. provisional 60/787,523.

### BACKGROUND OF THE INVENTION

1. Field of the Invention

The present invention relates to health care, and more specifically relates to a device for containing human solid and fluid waste materials, especially medical waste such as emesis, stomach contents, bodily secretions, and other biological waste materials potentially subject to contamination by bacteria or other infectious agents, and the use of this containment system for safe containment and disposal of such waste.

2. Description of the Related Art

The medical industry daily needs to safely dispose of biological waste materials such as emesis, fecal matter, stomach contents, bodily fluids, and the like which are often contaminated with infectious agents such as hospital derived (nocosmial) bacteria and viruses.

For example, emesis, or contents of the stomach when eliminated by reflux through the esophagus is a noxious substance whose collection and disposal in institutional settings is an unpleasant realty. In addition to exhibiting a distinct and characteristic malodor emesis poses a health risk as it can be a transmitter of hazardous biological agents such as viruses and bacteria to those who come in contact therewith. For example, in some instances emesis may contain blood and therefore contain blood borne pathogens.

Because of the health risks and general unpleasantness posed thereby various medical devices have been developed to provide for emesis disposal. For example impermeable paper bags or “air-sickness” bags, provided with integral metal twist closures are well known. However, these bags while being compact and relatively inexpensive depend on the manual dexterity of a user to hold them in place over the mouth while vomiting. Moreover, it is difficult for a second person to hold a person in position, along with aiding in a proper positioning of a patient's head in the case of an incompetent or semi-conscious patient. Further, if the bag is not held firmly onto a patient's face there is the possibility of splashing during usage as well as the problem of spillage after usage.

Because of the inherent problems associated with conventional air-sickness bags various modifications are known. For example larger, more sturdy bags and rigid plastic containers are known which overcome some of these difficulties. Such containers may be provided with a screw-on cap to be installed after use, and internal baffles or splash guards, which may also function to limit spillage in the event an unclosed, used container is inadvertently laid on its side or upended. These rigid containers, while an improvement over conventional air-sickness bags in utility, require a significant amount of storage space because of their rigidity which renders them impractical for industrial settings with constrained storage space, e.g., planes and similar settings.

Another example of an emesis storage container is disclosed in U.S. Pat. No. 6,554,810. This patent discloses an emesis container comprising a substantially rigid frame defining a square opening; a flexible bag having a mouth, the bag being attached to the frame, the frame being located in the mouth of the bag to hold the mouth open: and a baffle mounted on the frame having about an inner circumference of the opening and projecting into the mouth of the bag for inhibiting an egress through said opening of collected fluid material.

Still another example of an emesis container is the collapsible emesis container disclosed in U.S. Pat. No. 6,589,220 which consists of a hollow body member comprised of a flexible material having an upper sphere-like portion with an open neck and a lower sphere-like portion with a closed base end, said body member being disposed generally symmetrically about a central axis extending between said neck and base ends, said body member having an interior wall defining an interior space; receiving means defined by said body member at said neck end being adapted to facilitate receiving and directing emesis or other matter into said interior space; and restricting means defined by said body member being adapted for restricting flow of emesis or other matter within said interior space.

Other examples of emesis containers are disclosed in U.S. Pat. Nos. 5,425,468; 4,610,039; 3,317,521; 3,797,734; 3,920,179; and 4,990,145 among others. However, notwithstanding these and other biological waste containment devices, e.g., emesis containment devices, improvements are needed that are easier to use, inexpensive, readily stored and which provide for sterile emesis containment after usage without significant risk of leakage or spillage.

### BRIEF DESCRIPTION OF THE FIGURES

FIG. 1 depicts the packaging (cardboard container) used to store subject emesis storage bags.

FIG. 2 shows how this cardboard container can be quickly and easily accessed by a user and a sterile disposable emesis containment device according to the invention removed therefrom.

FIG. 3 shows how an exemplary emesis containment device according to the invention pops open upon release from the package which houses the device.

FIG. 4 illustrates that the subject emesis containment device preferably has a large opening at the top which can be easily closed after usage by use of a pull-string attached to the opening thereby sealing the contents therein.

FIG. 5 shows an exemplary emesis containment device according to the invention (popped open) sitting on top of the storage package.

### SUMMARY OF THE INVENTION

In accordance with the present invention, a new and improved device for receiving and storing emetic or similar noxious biological materials e.g., stomach contents, fecal matter, urine and other bodily fluids is provided.

It is an object of the invention to provide a container for receiving medical and biological waste materials such as emesis, stomach contents, urine or fecal matter and the like that is compact and easily transportable.

It is a further object of the invention to provide and emesis containment device that is disposable.

It is another object of the invention to provide an emesis containment device that is easy and convenient to use, especially by infirm users.

Finally, it is an object of the invention to provide an emesis containment system that is not subject to the disadvantages of prior medical waste, e.g., emesis containment systems.

The present invention is believed to achieve all of these objectives.

The present invention involves an emesis containment device referred to by the inventors as a “Pop-up-Puke Bag” that is in a collapsed form prior to usage permitting easy storage in industrial settings such as hospitals, home health care facilities and skilled nursing facilities as well as. in airplanes, buses, hotels, boating, automobiles and other settings where a bathroom is not readily available or not practical because of user constraints.

The present medical waste, e.g., emesis containment system was developed by the present inventors after a family vacation wherein several children developed a stomach flu resulting in numerous trips to the bathroom unfortunately with expulsion of emesis along the way resulting in other family members catching the flu. This experience caused the inventors to consider that this experience would have been considerably more pleasant had adequate portable emesis containment devices been available. Immediately thereafter, one of the inventors on the same family trip had to be hospitalized for an infection obtained as a result of a surgical procedure about a month prior. During his hospital stay he was constantly nauseated, however, all the hospital provided in the means of emesis containment was a bean shaped plastic bowl. Needless to say this disposal means was unsatisfactory given that the odor was not effectively contained. These two experiences caused the inventors to contemplate developing an improved emesis containment device that is easy to use, disposable and which alleviates the problems of malodor and leakage during usage and storage and the health risks associated therewith.

These objectives are attained by the expandable, disposable waste container provided herein

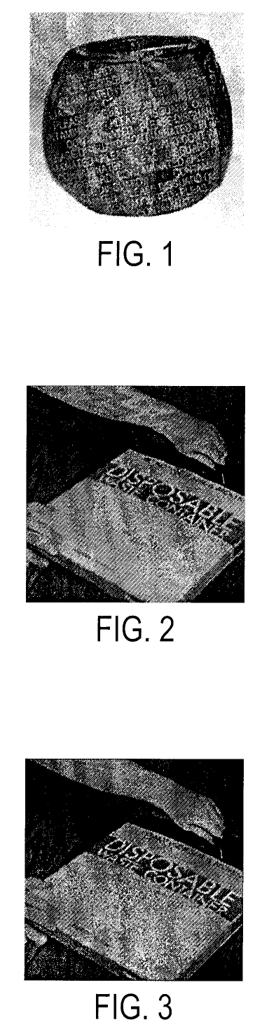

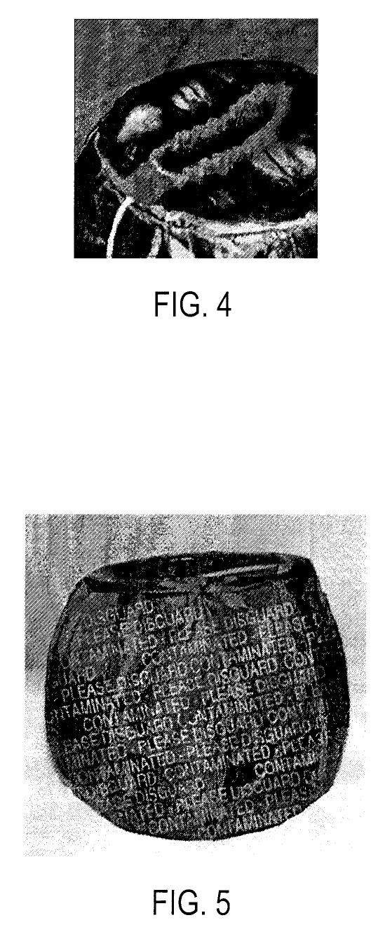

A prototype Pop-up Puke Storage device according to the invention and the manner of its usage is depicted in FIGS. 1-5. As shown therein, the subject device comprises a bag-like emesis storage means and a storage or packaging container for housing the emesis containment device prior to usage. While not depicted in the Figures, this container may optionally comprise handles or a devise to facilitate handling after usage. The bag-like emesis storage means preferably comprises a bag which may be constituted of a flexible, non-porous polymeric material e.g., a resilient stretchable non-porous polymer. In the preferred embodiment the bag will be comprised of a polymer such as Tyvek (the plastic material typically used by Fedex) or other readily available stretchable polymers such as those used in disposable garbage bags. Other examples of suitable materials for the bag include polyethylene, polypropylene, polyester, polyamide, polyvinylidene chloride polymers and co-polymers and the like.

Optionally the bag like container or storage means can have additional layers inside or outside the container. These additional layers may provide for splash containment as well as storage of additional elements. Additionally, the bag container may comprise excess material on the opening portion that functions to prevent the undesired splashing of medical waste placed therein such as emesis, bodily fluids or bodily secretions and the like.

Additionally, the interior of the bag may optionally be coated with or may contain one or more materials in particular odorant compounds that impart a pleasant odor and/or biocidal materials that further minimize the risk of spread of biohazardous materials during usage. For example, the coating may be impregnated with antiviral or antibacterial compounds. Additionally, the bag may comprise a desiccant or other material which acts to solidify the biological waste materials contained therein. Optionally, the exterior of the bag will be clearly marked to reveal its contents and to deter its opening after usage. In the prototype for example the bag is clearly marked “Contaminated”.

As shown in the Figures especially FIGS. 3-5, the bag desirably includes a supporting frame constituted of a metal or plastic material which is shaped like a spring and which supports the exterior bag material (e.g., Tyvek bag) during expansion (after the containment device is removed from the storage container, e.g., a cardboard container). As shown in FIGS. 2-5 this metal or plastic frame which is in the shape of a spring permits to bag to be compact when it is in the storage container and for it to pop open and expand after the emesis storage device is removed from the storage container. This supporting frame can be constituted of any flexible and resilient metal or plastic material that provides the requisite support and flexibility during expansion.

As shown in the Figures the subject containment device is preferably substantially spherical in shape. However, the shape can be varied if desired, e.g., the bag may be rectangular, square or cylindrical. The only requirement is that the bag on expansion, as a result of the supporting frame, have a large opening provided at the top which allows for a user to project emesis or other noxious biological waste material into the bag without it spilling or leaking therefrom.

The size of the bag is not critical to the invention other than the bag must be large enough to contain the emesis of at least a single expulsion (vomiting episode), stomach contents, fecal matter or urine from a user. It is anticipated that dimensions of about 6″ by 6″ by 6″ will be adequate for children and 12″ by 12″ by 12″ for adults. However, these dimensions are not critical and may be varied if desired. The opening is preferably 4-10″ inches in diameter.

In some use environments, such as hospitals and other medical facilities this waste container may be replaceable and be inserted into a permanent housing device which may be configured like a cup holder device which is easily refillable with numerous medical waste containers according to the invention and which upon release of one containment bag is immediately ready to release another.

Preferably, the emesis containment device or bag will comprise an opening at the top which permits it to open wide enough for the user to insert medical waste material such as emesis and which is easily closed. As noted it is anticipated that a 4-10 inch wide opening should be adequate for most intended usages. The closure means is desirably accomplished by pull or draw-string, zip-lock, Velcro, clip and the like which functions to securely and completely close the bag opening after usage thereby effectively sealing the contents and the odors associated therewith in the bag. Optionally, there may be a means for preventing the drawstring or other closure means from opening the bag after closure, e.g., the end of the drawstring may be affixed to a Velcro or adhesive strip attached to the bag after closure. Also, as noted above the storage bag will optionally be clearly marked with words that reveal its noxious contents, e.g., “contaminated”, “biohazard” and the like that dissuade opening after usage.

In the preferred embodiments the containment device will be used to contain emesis materials. However, it also may be used to contain other noxious biological materials in times of need, e.g., urine or fecal materials, stomach contents, blood, and other biological fluids and solid waste materials.

As depicted in FIGS. 1 and 2 the subject biological waste, e.g., emesis containment device or bag is preferably stored in unexpanded form prior to usage in a suitable container This container is typically a cardboard box the shape and size of which is dictated by the dimensions of the emesis containment device or bag. Preferably the package will be large enough to accommodate more than one bag in unexpanded form, e.g., from about 2-50 bags. This container may provide for the emesis containment device to remain sterile prior to usage.

Alternatively, the containment device may be housed in a closed, or partially open position within a housing device which may be affixed to a wall analogous to the Dixie cup holder seen in many medical settings. This device will similarly hold from about 50-100 of the subject containment devices and may be refilled as needed.

In a less preferred embodiment of the invention the emesis containment device or bag may be equipped with an interior plastic bag in order to permit the exterior bag and the supporting wire to be used multiple times. While this is potentially advantageous from a cost perspective it is less preferred given that reuse of the containment device increases the potential for the exterior bag and the associated supporting means, e.g., wire or plastic supporting structure to become contaminated during reusage This design may be preferred in some settings where cost is a significant concern, e.g. clinics and nursing home settings.

As noted above, the subject biological waste, e.g., emesis containment system may be used in any setting where emesis containment and storage is a prevalent concern, e.g. institutional settings such as hospitals, clinics, nursing homes, hospice facilities, schools, home health care and skilled nursing facilities. Additionally, the invention should be useful in airplanes, hotels, boats, buses and other vehicles or other settings where persons are prone to vomiting episodes e.g. because of motion.

Having now described the invention and an exemplary embodiment, it will be apparent to those skilled in the art that numerous alternatives, modifications, and variations of the embodiment can be made without departing from the spirit and scope of the following claims.

We claim:

1. An individual biological waste containment system adopted for individual usage by a user in need thereof which comprises the following:
(i) a bag-like storage means that is constituted of a substantially non-porous, flexible polymer that allows for expansion, which storage means comprises (ii) an expansion means or supporting frame structure that provides for the storage means to be stored substantially flat or substantially closed when it is in a storage package or permanent housing device and for it to rapidly expand (pop open) when removed from the package resulting in a large opening at the top of the bag-like storage means, wherein such bag-like storage means further comprises (iii) a closure means which allows for said opening at the to of the bag to be substantially sealed after usage; and
(iv) a means for storing or packaging at least one of said bag-like storage means that permits easily opening or access by an individual user of the individual biological waste containment device.

2. The biological waste containment system of claim 1 wherein the closure means (ii) is selected from a draw- or pull-string, zip-lock closure, Velcro closure, and a clip.

3. The biological waste containment system of claim 1 wherein the storage means (iv) is a plastic or cardboard container or package.

4. The biological waste containment system of claim 1 wherein the storage means (iv) is a permanent device that is refillable and which after delivery of one storage means is immediately able to deliver another.

5. The biological waste containment device of claim 4 wherein the permanent device is affixed to a wall.

6. The biological waste storage means of claim 1 wherein said bag-like storage means (i) or package (iv) is resealable.

7. The biological emesis storage means of claim 6 wherein said closure means for resealing is a Velcro or zipper or drawstring closure means.

8. The biological waste containment system of claim 1 wherein said baglike storage means (i) is constituted of a polymer selected from polyethylene, polypropylene, polyamide, polyester, polyvinylidene polymer or copolymer.

9. The biological waste emesis containment system of claim 1 wherein said bag-like storage means (i) is constituted of a Tyvek material.

10. The biological waste containment system of claim 1 wherein the supporting frame (ii) is constituted of a flexible metal material.

11. The biological waste containment system of claim 1 wherein the supporting frame (ii) is constituted of a hard, flexible plastic material.

12. The biological waste containment system of claim 1 wherein the interior of said bag-like storage means (i) comprises an odorant or fragrance compound that has a pleasant odor.

13. The biological waste containment device of claim 1 wherein the interior of said bag-like storage means (i) comprises a biocidal compound, desiccant or other compound that functions to solidify or decompose the waste contained therein.

14. The biological waste containment system of claim 1 wherein said bag-like storage means (i) ranges in size from about 6″×6″×6″ to about 12″×12″×12″.

15. The emesis containment system of claim 1 wherein the opening of the bag-like storage means after expansion ranges in size from about 4″×4″ to about 10″×10″.

16. The biological waste containment system of claim 1 wherein said bag-like storage means (i) after expansion is cylindrical, spherical, rectangular, or square in shape.

17. The biological waste emesis containment system of claim 1 wherein said bag-like storage means (i) comprises a draw- or pull-string closure means (iii) that may be affixed to the bag after closing.

18. The biological waste containment system of claim 1 wherein the bag-like storage means (i) has at least one additional layer inside or outside which prevents splash of contents and/or storage of additional materials.

19. The biological waste emesis containment system of claim 17 wherein the affixing means is a Velcro or resealable adhesive tab.

20. The biological waste containment system of claim 1 wherein the bag-like storage means (i) further comprises an interior plastic bag that is affixed to the aperture or opening of the bag-like storage means permitting the containment system to be reused upon disposal and replacement of the inner plastic bag.

21. The biological waste containment device of claim 1 wherein the outside of the bag-like storage means (i) is labeled to identify the contents of the bag as being biohazardous.

22. A method of containment and disposal of a noxious biomaterial using an individual biological waste containment system according to any one of claims 1-21 comprising the following steps:
(1) a user or other person removes the bag-like storage means (i) from its associated storage or packing means;
(2) the user or other person allows expansion means (ii) in said bag-like storage means to expand resulting in a bag-like structure with a large opening at the top;
(3) after expansion a user introduces a noxious biological material into the opening of said expanded bag-like storage means; and
(4) said user or other person thereupon seal the bag-like storage means using the closure means (iii).

23. The method of claim 22 wherein the biological material is selected from emesis, stomach contents, sputum, urine, fecal matter, and other biological fluids or bodily secretions.

24. The method of claim 22 wherein the biological material is emesis.
